(19) United States
(12) Patent Application Publication
(10) Pub. No.: US 2009/0090524 A1
(43) Pub. Date: Apr. 9, 2009

(54) CORNER WEAR PROTECTION FOR SEEDING TOOLS

(75) Inventors: Duane E. Carson, JR., Hollidaysburg, PA (US); Don C. Rowlett, Bedford, PA (US); Rodger W. Mack, Bedford, PA (US)

Correspondence Address: KENNAMETAL INC.;Intellectual Property Department, P.O. BOX 231, 1600 TECHNOLOGY WAY, LATROBE, PA, 15650, US

(73) Assignee: KENNAMETAL INC., Latrobe, PA (US)

(21) Appl. No.: 11/866,688

(22) Filed: Oct. 3, 2007

(51) Int. Cl. A01B 76/00

(52) U.S. Cl. 172/772

(57) ABSTRACT

A wear protection insert for an agricultural seeding tool having at least one angled edge on its lower base. The insert is made from wear resistant material shaped at an angle preferably ranging from about 135 to 175 degrees to form a doglegged corner component to improve the wear resistance of the soil slicing edge to the seeding tool.

### BACKGROUND OF THE INVENTION

1. Field of the Invention

The present invention relates to a wear resistant insert. More particularly, this invention relates to a wear resistant insert for use on a seeding tool/soil splitter-wedge to improve wear resistance along the seeding tool angled edges.

2. Description of the Related Art

There are numerous devices for today's farmers to till huge tracks of land for the insertion of seeds, planting and eventual harvesting of crops. A modular seed planting system as known in the art is described in commonly owned U.S. Pat. No. 6,318,279. It includes an elongated tool bar for a tractor that can be supported for movement across and over a field for furrowing. A plurality of seed planting units can be extended downwardly from that tool bar. Such seeding tools wedge or furrow into the ground, about ½ to 1½ inch deep. This allows the ground to be lifted up without as much soil disturbance as might otherwise be experienced with a typical tiller/furrowing device. Referring to accompanying FIG. 1, there is a typical seeding tool 7 slicing through the soil 5, while riding partially submersed below the upper surface of the soil. Seeds and fertilizer are delivered by air through tubing behind the tool into the furrow created by the tool. After seed and fertilizer delivery, the ground is pressed down usually by a press wheel to return the ground to about the same condition as prior to seeding. Such a process causes less dust and less soil erosion than other tilling or furrowing methods.

Known seeding tools have been designed with furrowing wear edges like the seed boot insert of commonly owned U.S. Pat. No. 5,325,799. A wear resistant edge is also provided for the seed boot of commonly owned U.S. Pat. No. 5,697,308. An alternate configuration, a rotating disc blade, is shown and described in commonly owned U.S. Pat. Nos. 5,297,637 and 5,429,016.

A series of wedges, or triangularly shaped seeding tools, have been developed. Representative models include those of commonly owned U.S. Pat. Nos. 5,159,985, 5,310,009 and 5,314,029. Another ground opener tool design is depicted in U.S. Design Pat. No. 374,018. More recent improvements to seeding tool or boot attachments include those shown in U.S. Pat. Nos. 6,318279, 6,640,731, 6,745,709 and 6,966,270.

One of the goals in modern agriculture is to plant seeds in a uniform trench or furrow while creating as little soil disturbance as possible during the seeding process. A common problem with many known seeding and furrowing tools is that they wear out over time as a result of contact with sand, rocks, roots and other hard and abrasive materials that are found in the soil. Excessive wear on a V-shaped tool causes the seeding tool to have a less angular and more round profile. Such a tool will tend to bulldoze through the soil creating furrows that do not have an angular profile and are rounded or U-shaped. Such rounded furrows tend to disturb the soil more than sharply cut, angled furrows. The seeds that are fed into a trench or furrow having a rounded profile may bounce out or come to rest at various locations in the furrow rather than being placed consistently at the preferred bottom center of the furrow. In addition, wear on the furrow forming tool over time causes a reduction in the depth of the furrows that the tool forms, necessitating continual adjustments to the tool cutting depth and resulting in lost time and diminished cost effectiveness.

The present invention addresses an insert wear concern for V-shaped agricultural tools, or those having a bend or angle along their base. In prior art tools, the straight segmented inserts that join at a corner tended to crack and chip at the insert-to-insert joint. This invention overcomes that problem by removing the joint from the tool corner. The present invention provides a wear resistant insert for the critical angled portions of the tool cutting edge that will prolong the wear life for the tool. Accordingly, one aspect of the present invention is to provide an improved wear resistant insert which can be bonded to an angled portion of the cutting edge of an agricultural tool

Another aspect of the present invention is to provide a uniquely shaped insert that is economical to manufacture and bondable to an agricultural seeding tool to increase its wear life. Yet another aspect of the invention provides a soil slicing tool which will reduce the downtime needed for replacing worn tools, thereby improving seed-to-soil contact, seeding efficiencies and helping to create slices and/or furrows having a uniform depth.

### SUMMARY OF THE INVENTION

The present invention provides a wear resistant insert for an agricultural seeding tool having one or more bends in its lower base. The insert is made from wear resistant material shaped at an angle ranging from about 135 to 175 degrees, and preferably between about 150 and 160 degrees. The insert provides wear protection to corners on the cutting edges of seeding and other furrow forming tools. In a preferred embodiment, the insert has a substantially uniform thickness from front to rear and its outside and inside edges extend substantially parallel to one another. More preferably, the insert has chamfered edges along its top and bottom for more uniform applications, i.e. reversible applications for the same seeding tool. These inserts may be made of cemented tungsten carbide, preferably including about 5 to 20 weight percent cobalt, and more preferably containing about 10 to 13 weight percent cobalt.

The aforementioned insert may be attached to a seeding tool by gluing, brazing, or any other affixation method to at least semi-permanently secure the insert to the corner portions of the tool.

### BRIEF DESCRIPTION OF THE DRAWINGS

Further features and other aspects of the invention will become clear from the following detailed description made with reference to the drawings in which:

FIG. 1 is a perspective view schematically depicting a typical seeding passing through a section of soil;

FIG. 2A is a partial side view schematic of a prior art seeding tool showing the area where typical wear inserts are positioned;

FIG. 2B is a bottom view schematic of the prior art seeding tool of FIG. 2A;

FIG. 3A is the bottom view of a prior art tool;

FIG. 3B is a close up bottom view of one embodiment of the seeding tool;

FIG. 4 is a bottom view schematic of the seeding tool depicted in FIG. 3B;

FIG. 5A is a top view of a wear resistant insert according to the present invention;

FIG. 5B is a top view of another embodiment of the wear resistant insert according to the invention;

FIG. 5C is a top view of another embodiment of the wear resistant insert according to the invention;

FIG. 5D is a partial cross-sectional side view of an embodiment of the wear resistant insert installed on a tool edge;

FIG. 5E is a partial cross-sectional side view of another embodiment of the wear resistant insert installed on a tool edge with a reverse taper to that shown in FIG. 5D;

FIG. 5F is a perspective view of an insert according to the present invention;

FIG. 6A is a perspective view of an insert according to the present invention;

FIG. 6B is a schematic view of the underside of the seeding tool insert of FIG. 6A;

FIG. 6C is an end view of the seeding tool insert from FIG. 6B taken along arrows VI-VI;

FIG. 7A is a perspective view of a seeding tool insert according to the invention;

FIG. 7B is a perspective view of a seeding tool insert according to the invention;

FIG. 8A is a perspective view of a seeding tool insert according to the invention having a chamfered top and bottom edge on the outside edge only;

FIG. 8B is a perspective view of a seeding tool insert according to the invention having chamfered top and bottom edges on both the inside and outside edges;

FIG. 8C is a perspective view of a seeding tool insert according to the invention having two chamfers on only the bottom (or top, depending on perspective) edge;

FIG. 9 is a perspective view of a seeding tool; and

FIG. 10 is a perspective view of the insert shown on the seeding tool in FIG. 9.

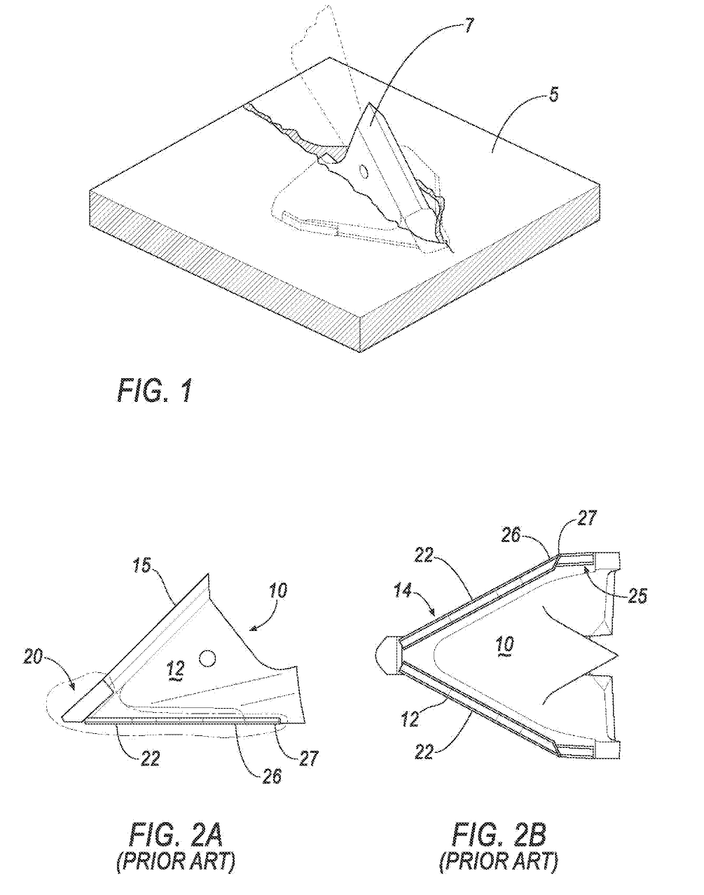

### DESCRIPTION OF THE PREFERRED EMBODIMENTS

In the following description, like reference characters designate like or corresponding parts. Also herein, it is to be understood that terms such as upwardly, forwardly, rearward, outwardly, inwardly, top, back, leading, trailing, lowermost and the like, are words of convenience and should not be construed as limiting. Finally, when referring to any numerical range of values herein, such ranges are understood to include each and every number and/or fraction between the stated range minimum and maximum. A dogleg angle between about 135 and 175 degrees, for example, would expressly include all intermediate values of about 136, 137, 140 and 145 degrees, all the way up to and including 171, 173 and 174.95 degrees. The same applies to each other numerical property and/or elemental range set forth herein.

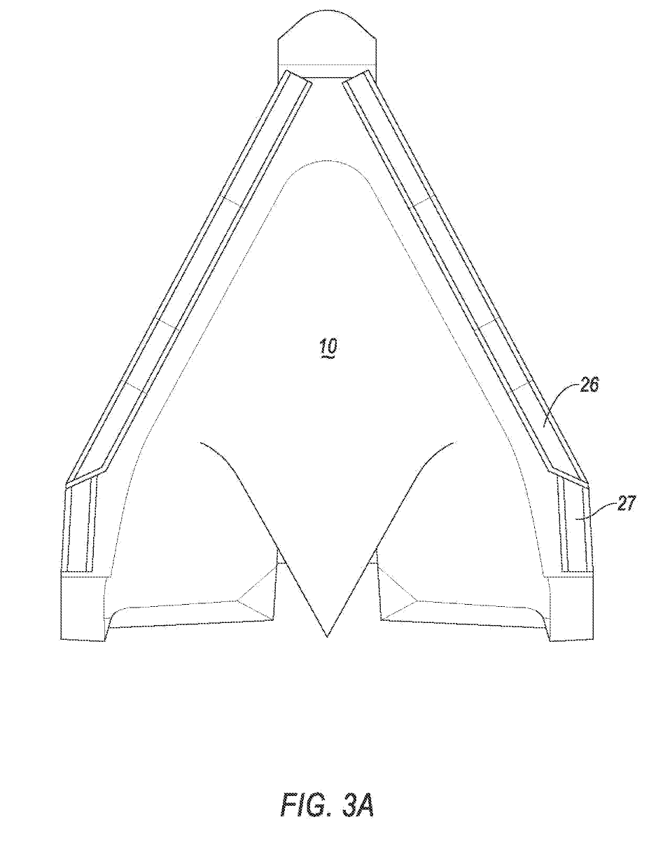

Referring to FIGS. 2A and 2B, there is shown a V-shaped seeding tool, generally item 10. The seeding tool has a pair of planar raised surfaces, side 12 and side 14 that meet to form a longitudinally extending V-shaped nose 15. Along the underside of tool 10, there extends a plurality of wear resistant, straight-sectioned inserts, cumulatively item 20 in FIG. 2A. The wear inserts in this particular embodiment of prior art seeding tool include, straight, sectioned elements 22 located along the lowermost base of the tool 10. Behind the V-shaped nose 15, there is a slight, rearward flare indicated by item 25 in FIG. 2B. To cover the lower edges of tool 10 where the V-shape ends and flare 25 begins, straight-sectioned inserts 26 and 27 may be beveled or angled at one end.

In FIG. 3A, there is shown the underside of a prior art seeding tool 10 with straight-sectioned inserts 26 and 27. FIG. 3B is a close up bottom view of tool 110 with angled insert 126.

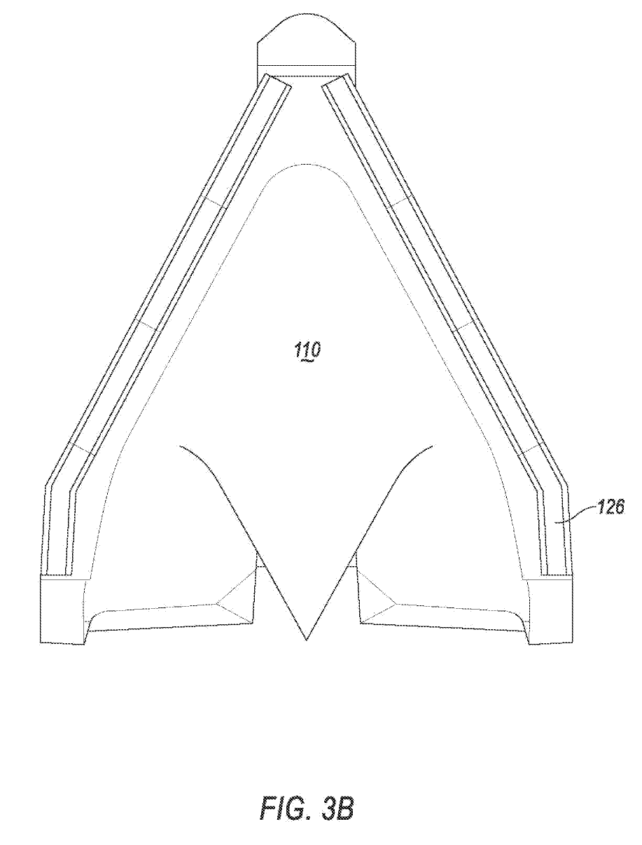

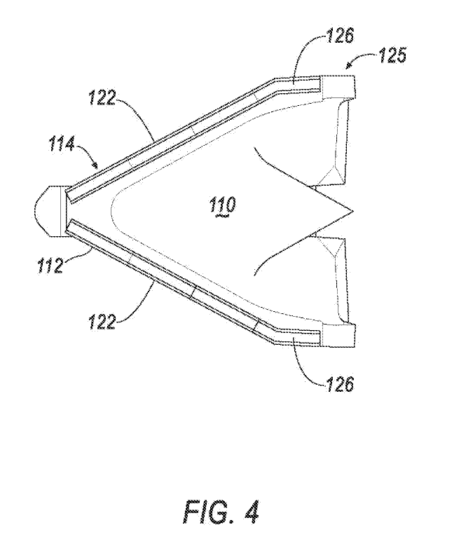

Referring now to remaining FIGS. 4 through 10, there are shown various preferred embodiments of wear inserts for using with a seeding tool that has a corner or angled base. For the alternate embodiments depicted, common elements are commonly numbered in the following “hundred” series.

In FIG. 4, the tool (generally 110) has a left side 112 and a right side 114 as shown. Behind the V-shaped part of same, a flare 125 extends rearward from both left side 112 and right side 114 in FIG. 4. It is to be understood, however, that seeding tools may have designs having edges with different flares, length, curvature, angle and/or consistency. It is intended that the wear resistant inserts of this invention can be used on any seeding tools that have edges with angled edges or corners.

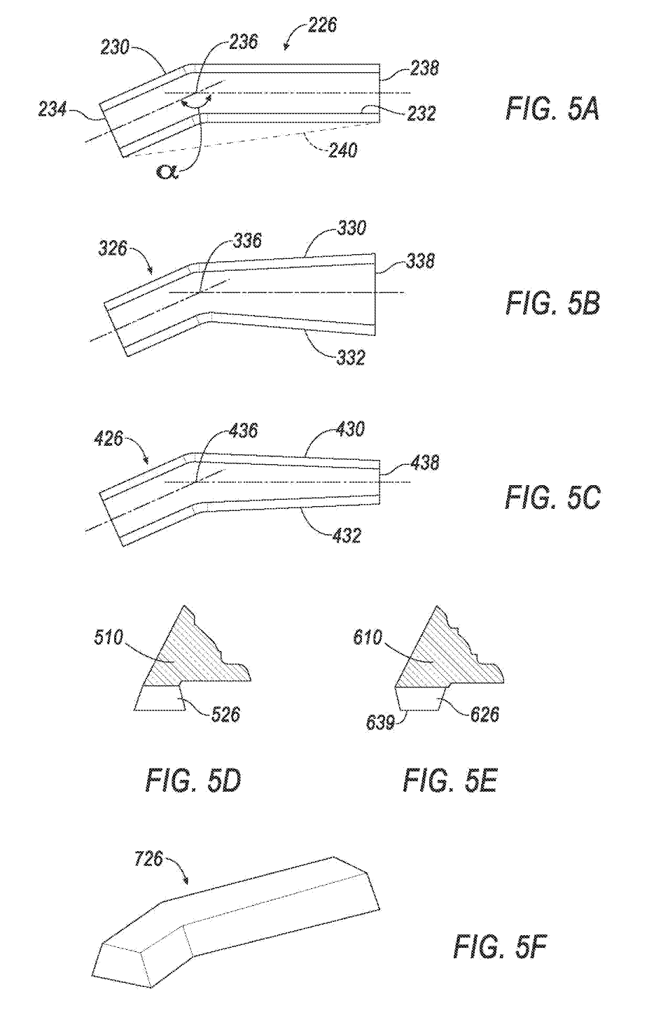

The wear resistant inserts of this invention can be used in conjunction with straight-sectioned wear inserts such as the inserts 122 shown in FIG. 4. In FIGS. 5A through 5F, several embodiments of insert 226 are shown. All embodiment variations include an outside edge 230 and an inside edge 232. As indicated with a dashed line through an imaginary center seam of insert 226, the forward end 234 runs to an intermediate point 236 of insert 226 before terminating at its rearward end 238. At intermediate point 236, the two parts of insert form an angle (indicated by alpha α). The angle α ranges between about 90 and 175 degrees, preferably between about 120 and 175 degrees, more preferably between about 135 and 175 degrees, and most preferably between about 150 and 160 degrees.

FIG. 5A shows an embodiment of wear insert 226 in which the outside edge 230 and inside edge 232 run substantially parallel to one another along the whole length of the insert, from forward end 234 to rearward end 238. Alternatively, the insert shown in FIG. 5A may not have an angled inside edge 232, and instead may have a straight edge as shown by dotted line 240.

FIG. 5B shows an alternative embodiment of insert 326, wherein outside edge 330 diverges from inside edge 332 from intermediate point 336 to rearward end 338 of the insert. Alternatively, FIG. 5C has an outside edge 430 that converges towards inside edge 432 after intermediate point 436, to rearward end 438 of insert 426.

FIG. 5D shows an insert 526 attached to an edge of tool 510. In this figure, it is apparent that an insert according to this invention may have side edges that taper upwardly, wider at its base and narrowing up to its upper surface, where it is connected to the underside of tool 510. Alternately, FIG. 5E shows the inverse of FIG. 5D. In this alternate configuration for insert 626, the sides taper inwardly from their connecting upper surface to a lowermost edge 639. In accompanying FIG. 5F, an insert 726 has lateral tapering sides extending along its entire length as shown. FIG. 5F is a variation of the insert from FIG. 5D, with upper, inward tapering along its whole length. If this particular insert were flipped upside down, it would more closely resemble the partial, cross-sectional insert depicted in FIG. 5E. The direction of attachment for these latter insert embodiments would depend on whether improved soil penetration was needed especially at start-up (FIG. 5D), or whether a wider/larger insert attachment surface was desired (FIG. 5E).

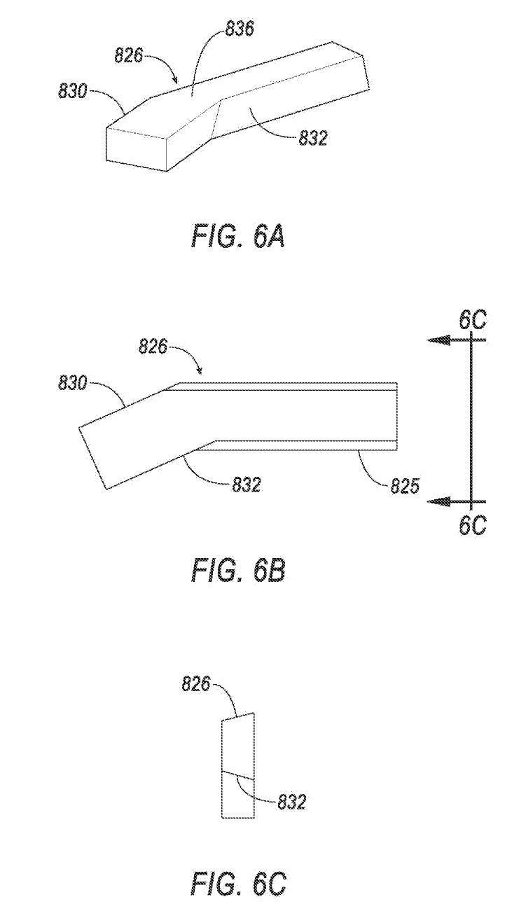

FIGS. 6A through 6C show yet another embodiment of this invention insert. Particularly, the rearward portion of insert 826, after intermediate point 836, is consistently parallel between outside edge 830 and inside edge 832. But the width of insert 826, aft of intermediate point 836 is noticeably smaller resulting in a trapezoidal cross-sectional shape similar to that shown in accompanying FIG. 5F. This could be used for a seeding tool that has a thinner walled area for its flare regions 825 and/or for cutting a wider or narrower swath depending on the application. It could also provide a better transition between carbide and steel components from tool assembly to the tool proper on its outside edge.

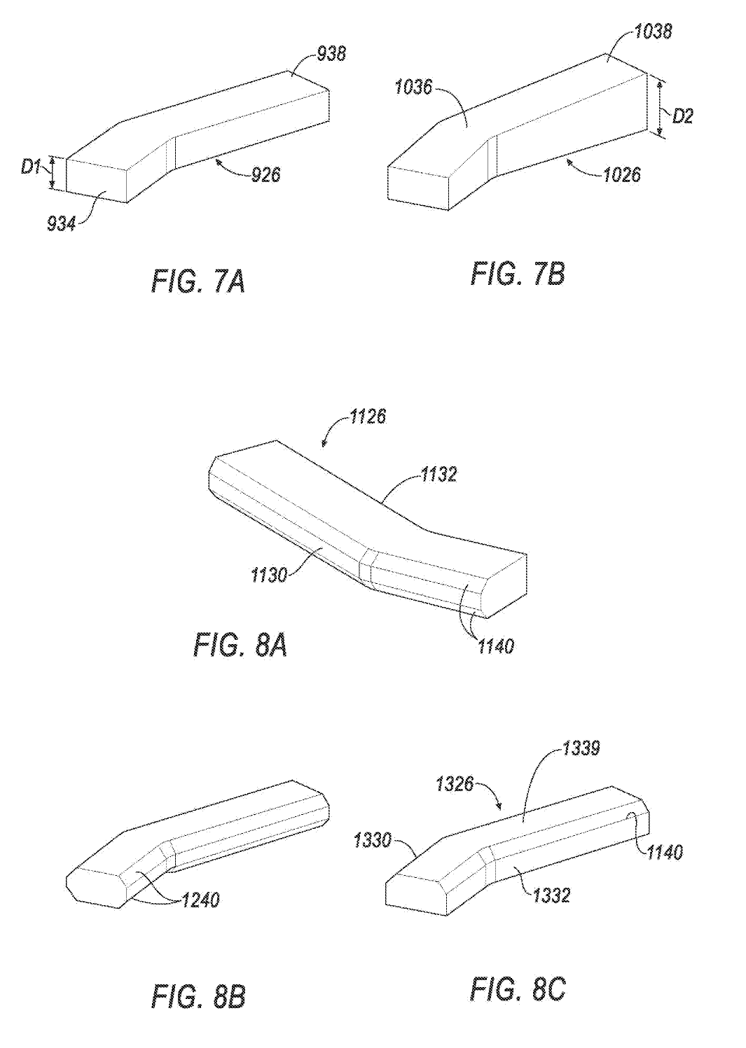

FIGS. 7A and 7B show embodiments of the insert having a differing thickness along the length (i.e. “installed axis”) of each insert. The insert in FIG. 7A has a uniform part thickness from forward end 934 to rearward end 938. Alternatively, FIG. 7B shows an embodiment in which the general thickness of insert 1026 gradually increases from the intermediate point 1036 to the rearward end 1038 of this variation. It is to be understood that the opposite of FIG. 7B is also conceivable, i.e., a wear insert that decreases in thickness from intermediate point 1036 to rearward end 1038. Additionally, insert thickness can vary across the whole length, or width, as desired for applying greater amounts of wear resistant materials in higher wear insert areas.

More preferred embodiments of this invention would include a chamfer cut along all or a substantial portion of one edge of the insert. In FIG. 8A, this chamfer 1140 extends along the entire upper and lower lengths of outside edge 1130 while inside edge 1132 of insert 1126 remains straight or completely unchamfered. FIG. 8B, by contrast, includes chamfers 1240 to both the upper and lower edges, as well as both its inside and outside edges for better side-to-side reversibility and left-to-right interchangeability for attachment to the underside of the same seeding tool (not shown). If left-to-right interchangeability is not critical for a particular use, FIG. 8C offers yet another alternative embodiment in which the insert 1326 chamfers along the entire top 1339 surface, both inner edges 1332 and outer edges 1330.

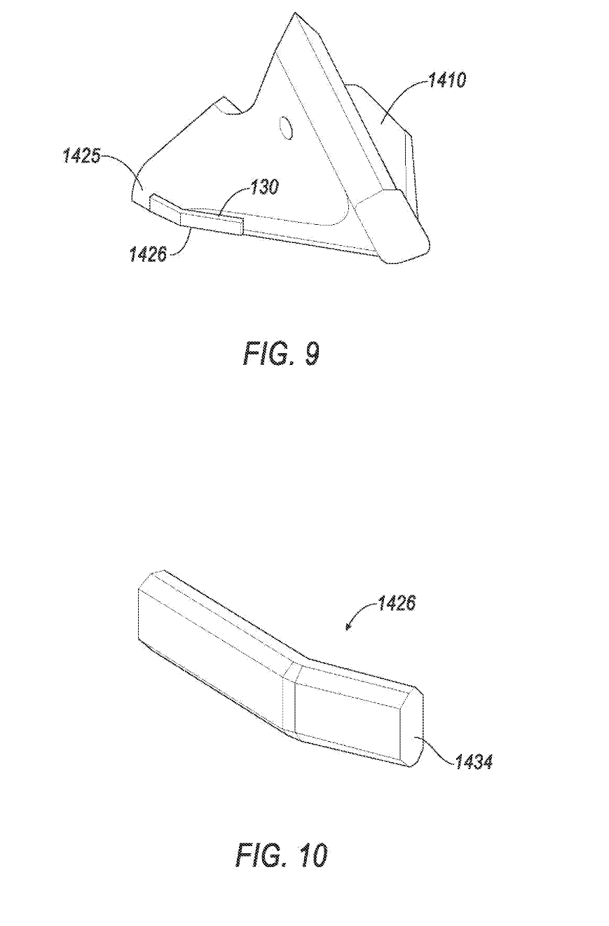

In FIGS. 9 and 10, there is yet another embodiment of insert for a V-shaped, seeding tool 1410. In this embodiment, the wear insert 1426 extends over a leading sidewall portion of the tool instead of, or more preferably in addition to, extending over the rearward base and flare 1425 of tool 1410. In FIG. 9, insert 1426 adheres to the left forward end of tool 1410. As shown in this configuration, the longer section is positioned along forward edge of the seeding tool. But in the close up view (FIG. 10), the configuration is flipped or inverted (as would be possible with full edge chamfering) so that its forward end 1434 runs from right to left.

The aforementioned seeding tool may be fastened to an appropriate seeder of a type well known in the art such as a Case New Holland Model 6000 No Till Air Drill.

Preferably, beveled side insert edges provide means for aligning with an appropriately configured slot (not shown). Such mounting provides lateral stability to the insert as it is exposed to the cutting forces of a tool as it slices (or cuts) through the soil. An insert duly aligned with its appropriately configured slot also provides an increased surface area for attachment during assembly thereby increasing the bond effectiveness between seeding tool and insert. Also, chamfers on exposed sides away from the attachment joint prevent wear material from chipping during operation or use.

The wear insert should be made from cemented tungsten carbide containing a cobalt binder. A preferred composition contains about 5-25 weight percent cobalt, more preferably between about 10 to 13 wt. percent Co. And while cemented tungsten carbide may be preferred for this application, other super hard wear resistant materials such as ceramics or cermets may be used as a supplement and/or substitute. For example, chromium carbide-coated metals and other cermets where titanium carbide or vanadium carbide is added to tungsten carbide may be candidates for insert materials hereunder. And alternate ceramics for such applications include aluminum-based, silicon based, zirconium-based and glass varieties. Still other insert material alternatives include cubic refractory, transition metal carbides or any other known or subsequently developed material(s) harder than the base material. The insert itself may be attached, mechanically or otherwise, via brazing or gluing using conventional compositions and techniques known to those skilled in the art.

Having described presently preferred embodiments of the invention, it is to be understood that it may be otherwise embodied within the scope of the appended claims.

What is claimed is:

1. A wear protection insert for use on an agricultural seeding tool having at least one angled edge, said insert comprising an angled, wear resistant member having an angle ranging from about 90 to 175 degrees.

2. The wear protection insert of claim 1, wherein said angle ranges from about 135 to 175 degrees.

3. The wear protection insert of claim 2, wherein said angle ranges from about 150 to 160 degrees.

4. The wear protection insert of claim 1, wherein said insert has a top, a bottom, a front end, a back end, an angled outside edge and an angled inside edge.

5. The wear protection insert of claim 4, wherein said inside edge is substantially planar.

6. The wear protection insert of claim 4, wherein said outside edge and said inside edge extend substantially parallel to each other.

7. The wear protection insert of claim 4, wherein said outside edge converges toward said inside edge at one or both ends.

8. The wear protection insert of claim 4, wherein said outside edge diverges from said inside edge at one or both ends.

9. The wear protection insert of claim 4, wherein at least one of said inside or outside edges is chamfered.

10. The wear protection insert of claim 4, wherein said inside edge is chamfered and said outside edge is chamfered.

11. The wear protection insert of claim 1 which is made from a material selected from the group consisting of tungsten carbide, cermets, a chromium carbide-coated metal, an aluminum-based ceramic, a silicon-based ceramic, a zirconium-based ceramic, a glass ceramic, a cubic refractory, a transition metal carbide and combinations thereof.

12. The wear protection insert of claim 11, wherein the material is a cemented tungsten carbide that includes about 5 to 25 weight percent cobalt.

13. The wear protection insert of claim 12, wherein said cemented tungsten carbide includes about 10 to 13 weight percent cobalt.

14. A wear protection insert for an agricultural seeding tool having a top, a bottom, a front end, a back end, an angled outside edge and an angled inside edge, said insert comprising an angled, wear resistant member having an angle ranging from about 90 to 175 degrees.

15. The wear protection insert of claim 14, wherein said angle ranges from about 135 to 175 degrees.

16. The wear protection insert of claim 15, wherein said angle ranges from about 150 to 160 degrees.

17. The wear protection insert of claim 14 which is chamfered substantially along its outside and/or inside edges.

18. The wear protection insert of claim 14 which is chamfered substantially along its top and/or bottom edges.

19. The wear protection insert of claim 14 which is made from a material selected from the group consisting of tungsten carbide, cermets, a chromium carbide-coated metal, an aluminum-based ceramic, a silicon-based ceramic, a zirconium-based ceramic, a glass ceramic, a cubic refractory, a transition metal carbide and combinations thereof.

20. The wear protection insert of claim 19, wherein the material is a cemented tungsten carbide that includes about 5 to 25 weight percent cobalt.

21. An agricultural tool wear protection insert comprising an angled, wear resistant member having a top, a bottom, a front end, a back end, an angled outside edge and an angled inside edge, wherein said angled inside edge and said angled outside edge each have an angle that ranges from about 90 to 175 degrees and wherein said insert is made from a material selected from the group consisting of tungsten carbide, cermets, a chromium carbide-coated metal, an aluminum-based ceramic, a silicon-based ceramic, a zirconium-based ceramic, a glass ceramic, a cubic refractory, a transition metal carbide and combinations thereof.
